(19) United States
(12) Patent Application Publication
(10) Pub. No.: US 2016/0018940 A1
(43) Pub. Date: Jan. 21, 2016

(54) METHOD FOR INCREASING SIGNAL TO NOISE RATIO OF CAPACITIVE TOUCH DEVICE AND CAPACITIVE TOUCH DEVICE AND TOUCH PANEL USING THE SAME

(71) Applicant: Generalplus Technology Inc., Hsinchu City (TW)

(72) Inventors: Li Sheng LO, Zhubei City (TW); Chih-Yuan YANG, Jhubei City (TW)

(21) Appl. No.: 14/714,040

(22) Filed: May 15, 2015

(30) Foreign Application Priority Data
Jul. 18, 2014 (TW) 103124731

(51) Int. Cl. G06F 3/041; G06F 3/0354; G06F 3/044

(52) U.S. Cl. CPC G06F 3/0416; G06F 3/044; G06F 3/0418; G06F 3/0412; G06F 3/03545; G06F 3/03547; G06F 2203/04101; G06F 2203/04104; G06F 2203/04111; G06F 2203/04808; G06F 2203/04103

(57) ABSTRACT

A method for increasing a signal to noise ratio of a capacitive touch device and a capacitive touch device and a touch panel using the same are provided. The capacitive touch device includes a first sensing electrode, a second sensing electrode, a touch detector, a resonant inductor and a detection signal output circuit.

An output terminal of the detection signal output circuit outputs a detection signal, such that the resonant inductor and an equivalent capacitor of the first sensing electrode are resonant, and the first sensing electrode receives a resonant sinusoidal wave. When an electric field signal detected by the detecting terminal of the touch detector is smaller than a preset value, it is determined that the capacitive touch device is touched.

This application claims priority of No. 103124731 filed in Taiwan R.O.C. on Jul. 18, 2014 under 35 USC 119, the entire content of which is hereby incorporated by reference.

### BACKGROUND OF THE INVENTION

1. Field of the Invention

The present invention relates to capacitive sensing technology, and more particularly to a method for increasing a signal to noise ratio of a capacitive touch device and a capacitive touch device and a touch panel using the same.

2. Related Art

Typically, a touch panel is attached to a liquid crystal display or a notebook computer, and functions to let the general user complete the data transmission or read the message on the display by using a finger or a touch pen to gently press the option on the touch panel. The touch panel has the relatively wide application range including: (a) portable information, consumer electronic and communication products, such as a personal digital assistant (PDA), a tablet computer, a digital camera, an information home appliance, a 3G mobile phone and the like; (b) a financial or commercial usage, such as a cash dispenser, a sales system, a remote video conference and a telephone terminal system; (c) an industry usage, such as a factory automation control system, a central monitoring system and a workstation operation system; and (d) a general information purpose, such as an airport, station or mall navigation service, a presentation, a data search and the like.

The sensing principle of the touch panel is based on that an analog signal is outputted when the finger touches the touch panel, and the controller converts the outputted analog signal into the digital signal that can be accepted by the computer. Then, the touch driver in the computer integrates and compiles each element. Finally, a display signal is outputted from a display card, and the touched position is displayed on the display.

FIG. 1 is a schematic view showing a conventional capacitive touch panel. Referring to FIG. 1, this capacitive touch panel is a mutual capacitance capacitive touch panel. The touch panel includes a driving electrode 101, a receiving electrode 102 and a pulse output circuit 103. The pulse output circuit 103 outputs a pulse with 3.3 V to the driving electrode 101. The driving electrode 101 generates an electric field signal to the outside. When the finger touches the capacitive touch panel, a portion of the electric field is absorbed by the finger to change the charge/discharge time.

For the thin flat touch surface, this method is indeed feasible. However, once the thickness of the touch panel is increased (greater than 3 mm), the conventional low amplitude (3.3V) square wave is not feasible due to the insufficient signal to noise ratio (SNR).

### SUMMARY OF THE INVENTION

It is therefore an object of the present invention to provide a method for increasing a signal to noise ratio of a capacitive touch device and a capacitive touch device and a touch panel using the same so that the touch sensitivity is enhanced.

In view of this, the present invention provides a touch panel including M first-axis sensing electrodes, N second-axis sensing electrodes, a touch detector, M resonant inductors and a detection signal output circuit. The touch detector includes N detecting terminals. The I^{th} detecting terminal of the touch detector is coupled to the I^{th} second-axis sensing electrode. Each resonant inductor includes a first terminal and a second terminal. The first terminal of the J^{th} resonant inductor is coupled to the I^{th} first-axis sensing electrode. The detection signal output circuit includes M output terminals. The K^{th} output terminal of the detection signal output circuit is coupled to the second terminal of the K^{th} resonant inductor. A detecting period is divided into M scanning periods. In the P^{th} scanning period, the P^{th} output terminal of the detection signal output circuit outputs a detection signal, so that the resonant inductor and an equivalent capacitor of the P^{th} first-axis sensing electrode are resonant, and the P^{th} first-axis sensing electrode receives a resonant sinusoidal wave. In the P^{th} scanning period, when an electric field signal detected by the Q^{th} detecting terminal of the touch detector is smaller than a preset value, it is determined that a (P, Q) coordinate of the touch panel is touched, wherein M, N, I, J, K, P and Q are natural numbers, 0<I<=N, 0<J<=M, 0<K<=M, 0<P<=M, and 0<Q<=N.

The present invention provides a capacitive touch device including a first sensing electrode, a second sensing electrode, a touch detector, a resonant inductor and a detection signal output circuit. The touch detector includes a detecting terminal. The detecting terminal of the touch detector is coupled to the second sensing electrode. The resonant inductor includes a first terminal and a second terminal. The first terminal of the resonant inductor is coupled to the first sensing electrode. The detection signal output circuit includes an output terminal. The output terminal of the detection signal output circuit is coupled to the second terminal of the resonant inductor. The output terminal of the detection signal output circuit outputs a detection signal, so that the resonant inductor and an equivalent capacitor of the first sensing electrode are resonant, and the first sensing electrode receives a resonant sinusoidal wave. When an electric field signal detected by the detecting terminal of the touch detector is smaller than a preset value, it is determined that the capacitive touch device is touched.

The present invention provides a method for increasing a signal to noise ratio of a capacitive touch device. The capacitive touch device includes a first sensing electrode and a second sensing electrode. The method includes the steps of: coupling a resonant inductor between the first sensing electrode and a pulse providing source; providing a resonant square wave of a resonant frequency constituted by the resonant inductor and an equivalent capacitor of a circuit node of the first sensing electrode; making the resonant inductor and the equivalent capacitor of the first sensing electrode become resonant, so that the first sensing electrode receives a resonant sinusoidal wave; and detecting an electric field of the second sensing electrode to judge whether the capacitive touch device is touched.

The spirit of the present invention is to couple an inductor between the capacitive touch device and the detection signal, and to make the inductor and the capacitive touch device become resonant using the detection signal in conjunction with the resonant frequency between the inductor and the capacitor to amplify the detection signal. Thus, when the capacitive touch device is not touched, a substantial amplitude of the detection signal is amplified to get rid of the mis-judgement. When the capacitive touch device is touched, the resonant frequency is offset, thereby causing the detection signal being attenuated. Therefore, the present invention can increase the signal to noise ratio of the capacitive touch device and the overall touch panel and the ability against the interference.

Further scope of the applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

FIG. 1 is a schematic view showing a conventional capacitive touch panel.

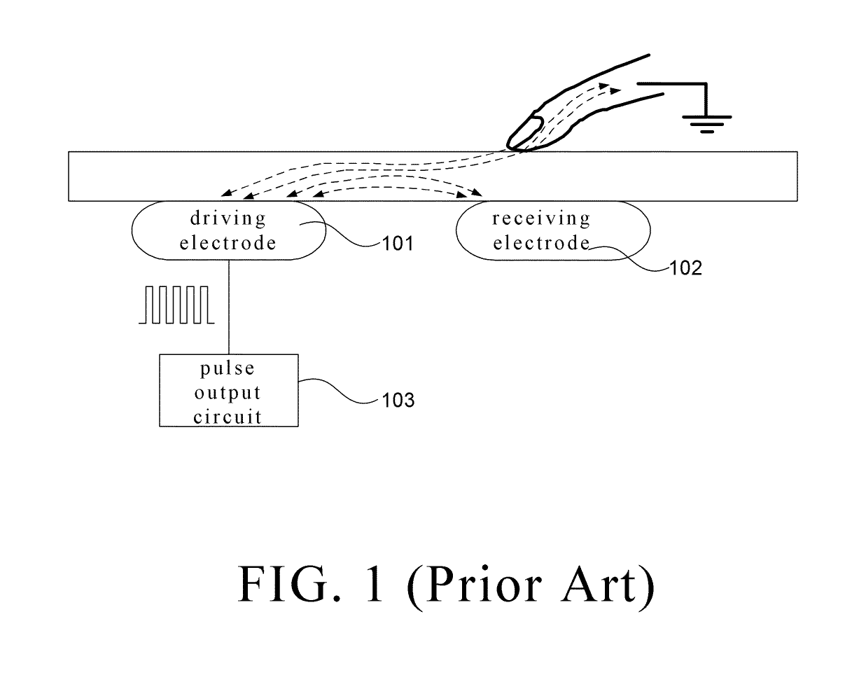

FIG. 2 is a circuit diagram showing a capacitive touch device according to a preferred embodiment of the present invention.

FIG. 3 is a circuit diagram showing a capacitive touch device according to a preferred embodiment of the present invention.

FIG. 4 is a circuit diagram showing a touch panel according to a preferred embodiment of the present invention.

FIG. 5 shows an operation waveform chart of a detection signal output circuit 404 of a touch panel according to a preferred embodiment of the present invention.

### DETAILED DESCRIPTION OF THE INVENTION

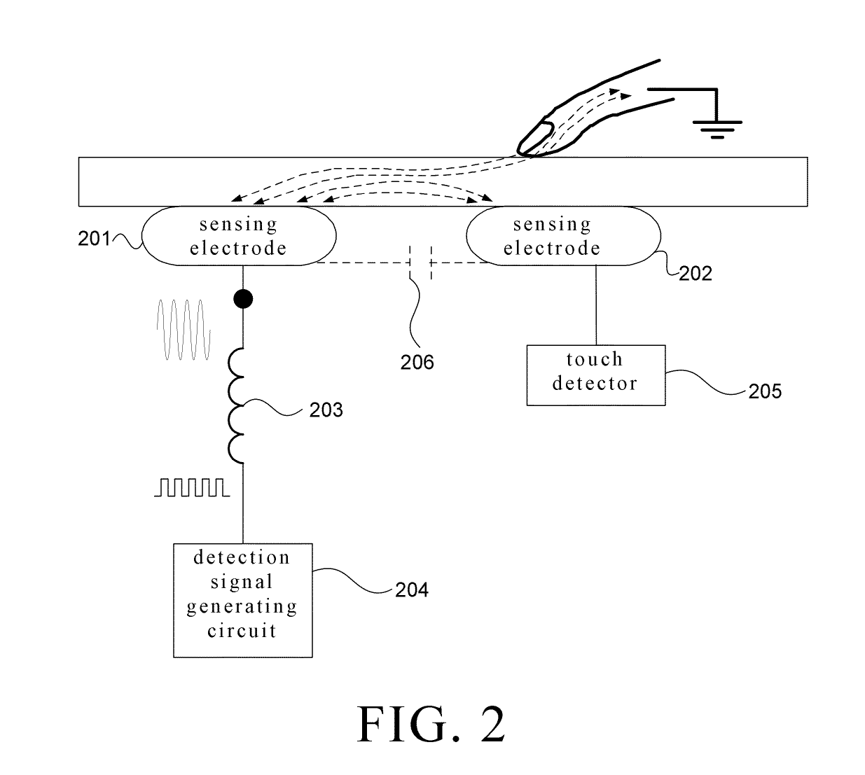

FIG. 2 is a circuit diagram showing a capacitive touch device according to a preferred embodiment of the present invention. Referring to FIG. 2, the capacitive touch device includes a first sensing electrode 201, a second sensing electrode 202, a resonant inductor 203, a detection signal generating circuit 204 and a touch detector 205. In order to make those skilled in the art understand the present invention, a node N20 and an equivalent capacitor 206 are additionally depicted in this embodiment.

In this embodiment, the resonant inductor 203 is disposed between the detection signal generating circuit 204 and the first sensing electrode 201 in order to prevent the increase of the thickness of the glass from causing the incapability of sensing, and in order to increase the touch sensitivity without increasing the output voltage of the detection signal generating circuit 204. In addition, when this circuit operates, a frequency of a resonant pulse signal RP outputted from the detection signal generating circuit 204 approaches a resonant frequency between the resonant inductor 203 and the equivalent capacitor 206.

Therefore, when the detection signal generating circuit 204 emits the resonant pulse signal RP, the first sensing electrode 201 receives a resonant sinusoidal wave signal RS. Because this circuit operates at the resonant frequency, the amplitude of the real-time resonant pulse signal RP is equal to 3.3 V, and the amplitude of the resonant sinusoidal wave signal RS may be several times greater than that of the resonant pulse signal RP. In addition, when the capacitive touch device is touched, the resonant frequency is offset because the equivalent capacitor 206 is touched by the finger touch. At this time, the amplitude of the resonant sinusoidal wave signal RS is significantly attenuated. Correspondingly, the electric field signal detected by the touch detector 205 from the second sensing electrode 202 is significantly decreased. Therefore, the signal to noise ratio (SNR) of the capacitive touch device is significantly increased.

The resonant pulse signal RP of the above-mentioned embodiment may have a square wave, a triangle wave, a sinusoidal wave, or the like. So, the present invention is not restricted thereto.

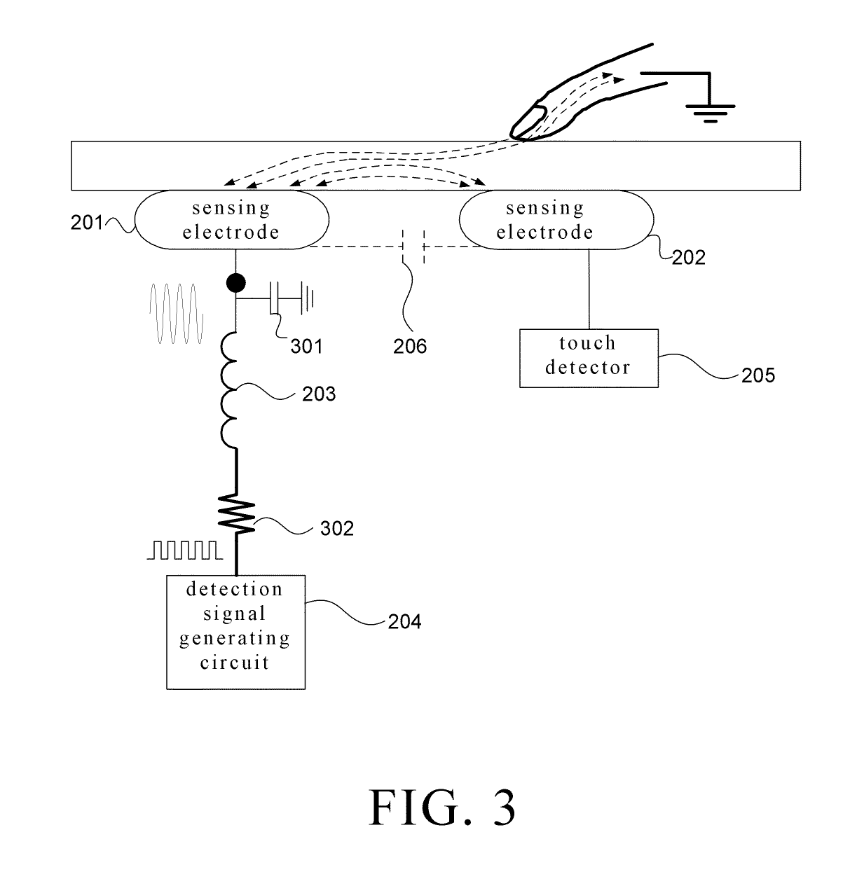

FIG. 3 is a circuit diagram showing a capacitive touch device according to a preferred embodiment of the present invention. Referring to FIGS. 2 and 3, the difference between the capacitive touch device of FIG. 3 and the capacitive touch device of FIG. 2 resides in that the capacitive touch device of FIG. 3 additionally has an external resonant capacitor 301 and a quality factor resistor 302. Since the external resonant capacitor 301 has the stable capacitance, the resonant frequency is not changed owing to the manufacturing processes. In addition, the quality factor resistor 302 can adjust the gain and the bandwidth of the resonant circuit. Because the operation principles are the same, detailed descriptions will be omitted.

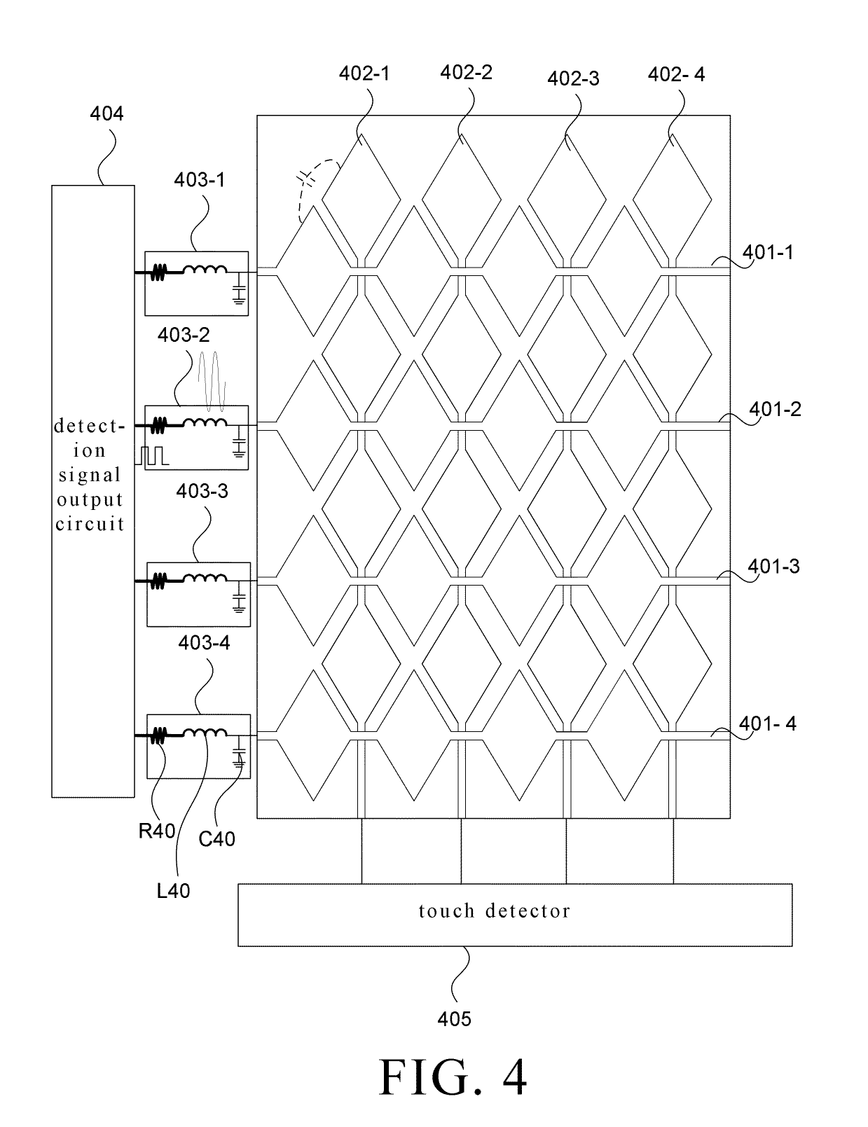

FIG. 4 is a circuit diagram showing a touch panel according to a preferred embodiment of the present invention. Referring to FIG. 4, this circuit includes X-axis sensing electrodes 401-1 to 401-4, Y-axis sensing electrodes 402-1 to 402-4, resonant circuits 403-1 to 403-4, a detection signal output circuit 404 and a touch detector 405. In this embodiment, the touch panel having 4×4 sensing electrodes is described as an example. However, those skilled in the art should know that the sensing electrode matrix is not restricted to the arrangement of the 4×4 sensing electrodes. In other words, the size of the sensing electrode matrix may be changed to, for example, 20×30 according to different design requirements. The present invention is not restricted thereto.

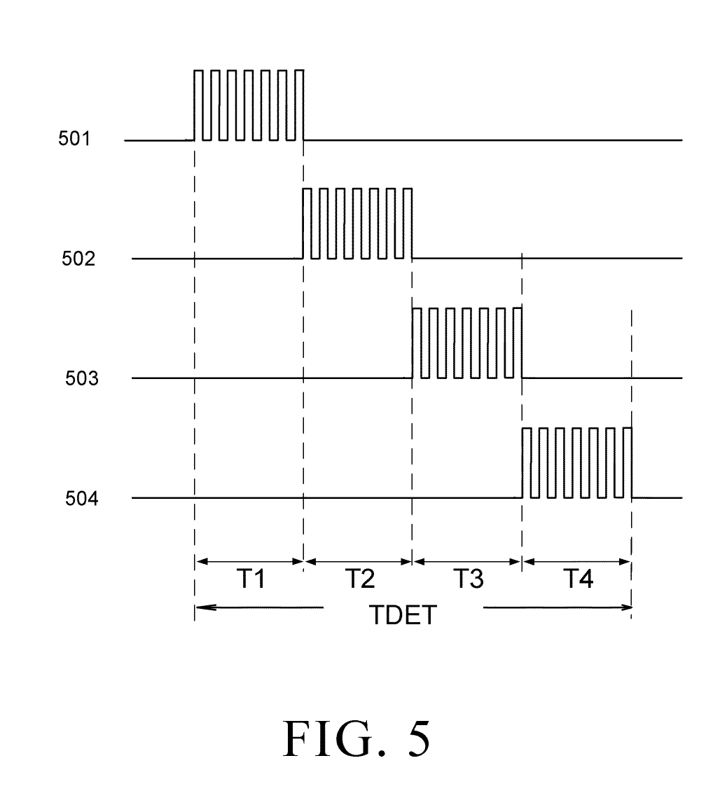

In the above-mentioned embodiment, each of the resonant circuits 403-1 to 403-4 includes a quality factor resistor R40, a resonant inductor L40 and a resonant capacitor C40. FIG. 5 shows an operation waveform chart of the detection signal output circuit 404 of a touch panel according to a preferred embodiment of the present invention. Referring to FIGS. 4 and 5, a detecting period TDET in this embodiment is divided into four scanning periods T1, T2, T3 and T4.

In the first scanning period T1, the detection signal output circuit 404 outputs a detection pulse 501 to the resonant circuit 403-1, and the resonant circuit 403-1 receives the detection pulse 501 to cause the resonance and generate a resonant sinusoidal wave, which has a larger amplitude and is outputted to the X-axis sensing electrode 401-1. In the second scanning period T2, the detection signal output circuit 404 outputs a detection pulse 502 to the resonant circuit 403-2, and the resonant circuit 403-2 receives the detection pulse 502 to cause the resonance and generate a resonant sinusoidal wave, which has a larger amplitude and is outputted to the X-axis sensing electrode 401-2. In the third scanning period T3, the detection signal output circuit 404 outputs a detection pulse 503 to the resonant circuit 403-3, and the resonant circuit 403-3 receives the detection pulse 503 to cause the resonance and generate a resonant sinusoidal wave, which has a larger amplitude and is outputted to the X-axis sensing electrode 401-3. In the fourth scanning period T4, the detection signal output circuit 404 outputs a detection pulse 504 to the resonant circuit 403-4, and the resonant circuit 403-4 receives the detection pulse 504 to cause the resonance and generate a resonant sinusoidal wave, which has a larger amplitude and is outputted to the X-axis sensing electrode 401-4.

Similarly, in the first scanning period T1, when an electric field signal detected by the third detecting terminal of the touch detector is smaller than a preset value, it is determined that the (1, 3) coordinate of the touch panel is touched. In the third scanning period T3, when an electric field signal detected by the second detecting terminal of the touch detector is smaller than a preset value, it is determined that the (3, 2) coordinate of the touch panel is touched. Because the detection method has been described in detail in the above-mentioned embodiment, detailed descriptions thereof will be omitted.

In summary, the spirit of the present invention is to couple an inductor between the capacitive touch device and the detection signal, and to make the inductor and the capacitive touch device become resonant using the detection signal in conjunction with the resonant frequency between the inductor and the capacitor to amplify the detection signal. Thus, when the capacitive touch device is not touched, a substantial amplitude of the detection signal is amplified to get rid of the mis-judgement. When the capacitive touch device is touched, the resonant frequency is offset, thereby causing the detection signal being attenuated. Therefore, the present invention can increase the signal to noise ratio of the capacitive touch device and the overall touch panel and the ability against the interference.

While the present invention has been described by way of examples and in terms of preferred embodiments, it is to be understood that the present invention is not limited thereto. To the contrary, it is intended to cover various modifications. Therefore, the scope of the appended claims should be accorded the broadest interpretation so as to encompass all such modifications.

What is claimed is:

1. A touch panel, comprising:
M first-axis sensing electrodes, wherein M is a natural number;
N second-axis sensing electrodes, wherein N is a natural number;
a touch detector comprising N detecting terminals, wherein an I^{th} detecting terminal of the touch detector is coupled to an I^{th} second-axis sensing electrode, wherein I is a natural number, and 0<I<=N;
M resonant inductors, wherein each of the resonant inductors comprises a first terminal and a second terminal, wherein a first terminal of the J^{th} resonant inductor is coupled to the I^{th} first-axis sensing electrode, wherein J is a natural number, and 0<J<=M; and
a detection signal output circuit comprising M output terminals, wherein a K^{th} output terminal of the detection signal output circuit is coupled to a second terminal of the K^{th} resonant inductor, wherein K is a natural number, and 0<K<=M;
wherein a detecting period is divided into M scanning periods, wherein in the P^{th} scanning period, the P^{th} output terminal of the detection signal output circuit outputs a detection signal, so that he resonant inductor and an equivalent capacitor of the P^{th} first-axis sensing electrode are resonant, and the P^{th} first-axis sensing electrode receives a resonant sinusoidal wave,
wherein in the P^{th} scanning period, when an electric field signal detected by the Q^{th} detecting terminal of the touch detector is smaller than a preset value, it is determined that a (P, Q) coordinate of the touch panel is touched,
wherein P and Q are natural numbers, and 0<P<=M, 0<Q<=N.

2. The touch panel according to claim 1, further comprising:
M resonant capacitors each comprising a first terminal and a second terminal, wherein the first terminal of the L^{th} resonant capacitor is coupled to the first terminal of the L^{th} resonant inductor, and the second terminal of the L^{th} resonant capacitor is coupled to a common voltage,
wherein L is a natural number, and 0<L<=M.

3. The touch panel according to claim 1, further comprising:
M quality factor resistors each comprising a first terminal and a second terminal, wherein the first terminal of the R^{th} quality factor resistor is coupled to the second terminal of the R^{th} resonant inductor, and the second terminal of the R^{th} quality factor resistor is coupled to the R^{th} output terminal of the detection signal output circuit,
wherein each of the quality factor resistors determines a resonant bandwidth and a voltage gain,
wherein R is a natural number, and 0<R<=M.

4. A capacitive touch device, comprising:
a first sensing electrode;
a second sensing electrode;
a touch detector comprising a detecting terminal, wherein the detecting terminal of the touch detector is coupled to the second sensing electrode;
a resonant inductor comprising a first terminal and a second terminal, wherein the first terminal of the resonant inductor is coupled to the first sensing electrode; and
a detection signal output circuit comprising an output terminal, wherein the output terminal of the detection signal output circuit is coupled to the second terminal of the resonant inductor;
wherein the output terminal of the detection signal output circuit outputs a detection signal, so that the resonant inductor and an equivalent capacitor of the first sensing electrode are resonant, and the first sensing electrode receives a resonant sinusoidal wave,
wherein when an electric field signal detected by the detecting terminal of the touch detector is smaller than a preset value, it is determined that the capacitive touch device is touched.

5. The capacitive touch device according to claim 4, further comprising:
a resonant capacitor comprising a first terminal and a second terminal, wherein the first terminal of the resonant capacitor is coupled to the first terminal of the resonant inductor, and the second terminal of the resonant capacitor is coupled to a common voltage.

6. The capacitive touch device according to claim 4, further comprising:
a quality factor resistor comprising a first terminal and a second terminal, wherein the first terminal of the quality factor resistor is coupled to the second terminal of the resonant inductor, and the second terminal of the quality factor resistor is coupled to the output terminal of the detection signal output circuit,
wherein the quality factor resistor determines a resonant bandwidth and a voltage gain.

7. A method for increasing a signal to noise ratio of a capacitive touch device, the capacitive touch device comprising a first sensing electrode and a second sensing electrode, the method comprising:
coupling a resonant inductor between the first sensing electrode and a pulse providing source;
providing a resonant square wave of a resonant frequency constituted by the resonant inductor and an equivalent capacitor of a circuit node of the first sensing electrode;
making the resonant inductor and the equivalent capacitor of the first sensing electrode become resonant, so that the first sensing electrode receives a resonant sinusoidal wave; and
detecting an electric field of the second sensing electrode to judge whether the capacitive touch device is touched.

8. The method according to claim 7, further comprising:
coupling a resonant capacitor between a node of the first sensing electrode and the resonant inductor and a common voltage to stabilize the resonant frequency.

9. The method according to claim 7, further comprising:
coupling a quality factor adjusting resistor between the pulse providing source and the resonant inductor to control a signal attenuation amount when the capacitive touch device is touched.
